(19) United States
(12) Patent Application Publication
(10) Pub. No.: US 2016/0221202 A1
(43) Pub. Date: Aug. 4, 2016

(54) COATED AND RECESSED INDUSTRIAL PAPER KNIFE

(71) Applicant: Jorson & Carlson, Elk Grove Village, IL (US)

(72) Inventor: Woodrow A. Powers, II, Johnsburg, IL (US)

(21) Appl. No.: 14/611,416

(22) Filed: Feb. 2, 2015

(51) Int. Cl. B26D 1/08; B26D 1/00

(52) U.S. Cl. CPC B26D 1/08; B26D 1/0006

(57) ABSTRACT

An industrial knife for attachment to a cutting machine is presented having a front beveled side and a back cutting side where the back cutting side has an upper portion that is recessed from a lower face to define an adhesive collection surface. The back cutting side and the bevel on the front beveled side is coated with a low friction coating material to reduce adhesive build-up on the blade faces of the knife during cutting and trimming of sheet media.

### TECHNICAL FIELD

This invention relates to an improved industrial knife, preferably a paper knife used to cut and/or trim stacked media, where the media can contain adhesives and other sticky compounds. More particularly, my invention is directed to an industrial knife that is coated with a low friction coating and has a recess above the cutting blade that, in combination with the low friction coating, greatly reduces adhesive build-up on the knife face, improves cut quality, and blade longevity. This disclosure also presents a method of retrofitting existing industrial knives to include the features disclosed herein for use in O.E.M. cutting machines.

### BACKGROUND

Non-rotary cutting single edged knifes for trimming media, such as paper products, are known to those skilled in the art of industrial paper cutting. Such media more frequently now contain adhesives and other sticky substances that are released when a lift of the media is cut or trimmed. Lifts of media can range from a thickness of from about 1 inch to about 6-8 inches. For example, adhesive-backed media is commonly used in the printing of labels, barcodes, laminates, books, magazines, and the like which are attached to an object after printing. Unfortunately, cutting adhesive-backed media is particularly troublesome in that the adhesive material is released during the cutting operation and adheres to the knife blade surfaces. Gradually the sticky substances causing gumming on the knife faces over time resulting in a number of operational problems, for example, degradation of the quality of the cut over the life of the blade where a complete cut is no longer possible. Also, the released adhesive can foul or gum-up the moving parts of the cutting machine. The adhesive build-up on the blades may also cause the cut media to stick to the cutting edge, which can ruin the visual appearance of the finished cut product. Correcting this adhesive build-up problem typically requires operator intervention to conduct multiple knife change outs resulting in lost production time of from 30 to 60 minutes. With typical machinery producing anywhere between about 1,000 to about 10,000 cuts per hour, frequent knife change outs for replacement or cleaning are very costly. Further, although straightforward in function, paper cutting machines typically include complex assemblies with numerous parts, which makes knife change outs time consuming.

Accordingly, a need exists for an improved industrial knife design that reduces adhesive build-up on the knife faces during a production run, minimizes machine downtime due to less knife change outs, and improves the quality of the cut media. My industrial knife design, as described herein, achieves these goals and overcomes the above-mentioned problems by providing a combination of a coated knife blade having a recess in the top portion of the knife face to allow adhesive build-up to accumulate away from the blade face and cutting edge. Improved cut quality and blade longevity is possible while cutting paper made from wood, synthetic paper and films because the improved blade disclosed herein generates less friction and accordingly less deflection.

These and other advantages of the invention will become evident from the following more detailed description of the invention.

### SUMMARY

My invention substantially reduces the amount of build-up of adhesives and other sticky substances from the cutting blade faces of an industrial knife, preferably paper knives. Build-up of sticky material on the cutting blade can result in fouling of both the knife and the cutting machine to which it is attached. This results in frequent and costly change out downtime as the blade is cleaned or replaced. In some instances, repair or cleaning of the cutting machine itself may also be needed.

An object of my invention is to configure the knife such that any adhesive from the cut media is transferred to locations on the knife so as not to interfere with the performance of either the knife itself or the combination of the knife and the cutting machine.

The above object is accomplished by the combination of two features of my industrial knife design. First is the use of non-stick or low friction coating applied to selected portions of the knife and second is incorporating a recess or cut-out in the knife face, preferably above the cutting blade portions of the knife Accordingly, one possible embodiment of my improved industrial knife for use in a trimming or cutting machine comprises a generally rectangular metal stock having a length L and a width W. The bottom section of the metal stock contains two blade portions or faces, one on the front beveled side and one on the back cutting side. The front beveled side comprises a bottom blade face that is beveled to an angle of less than 90 degrees as measured relative to a longitudinal axis that runs parallel to width W of the knife. A low friction coating is adhered to the outer surface of the bottom blade face. The back cutting side comprises a lower blade face and an upper end portion, where the upper end portion is recessed from the lower blade face to define a collection surface. A low friction coating is present on an outer surface of the lower end face and also on the collection surface.

Another possible embodiment of my invention includes a method of retrofitting an existing industrial paper knife to reduce adhesive build-up during use. This method comprises starting with an existing industrial knife that is configured as a metal stock having a length L and a width W with blade faces on the front beveled side and on the back cutting side. The front beveled side comprises a bottom blade face that is beveled to an angle of less than 90 degrees as measured relative to a longitudinal axis that is parallel to width W of the knife. The back cutting side comprises a lower blade face and an upper end portion, both of which lie in a single vertical plane. The back cutting side is flat and has no recess or other cut-out in the upper end section. My method further comprises removing a section of the upper end portion of the back cutting side to form a collection surface that defines a vertical plane that does not lie in the plane defined by the lower blade face. Preferably the two planes are parallel to each other.

Once the collection surface is formed, a low friction coating is then applied to the outer surface of the bottom blade face of the front beveled side, to the outer surface of the lower blade face and to the collection surface.

These as well as other possible embodiments and features of the various aspects of my industrial knife design will become apparent to those of ordinary skill in the art by reading the following detailed description, with appropriate reference to the accompanying drawings.

### BRIEF DESCRIPTION OF THE FIGURES

Exemplary embodiments are described herein with reference to the drawings, in which:

FIG. 1 illustrates a front view of one possible embodiment of my industrial knife disclosed herein showing the front beveled side with a low friction coating applied to the lower blade face;

FIG. 2 illustrates a back view of the knife illustrated in FIG. 1 showing the opposite back cutting side having a low friction coating applied thereto and a recess above the lower blade face;

FIG. 3 illustrates a cross-sectional view of the knife illustrated in FIG. 1 and showing the collection surface on the upper portion of the back cutting side along with the areas of the knife coated with the low friction coatings;

FIG. 4 illustrates one embodiment of my industrial knife mounted on a schematic representation of an industrial cutting machine and indicating a general directional path of the knife in operation; and

FIG. 5 illustrates the embodiment of the knife of FIG. 1 schematically represented in a side view cutting operation of media position on a cutting machine.

### DETAILED DESCRIPTION

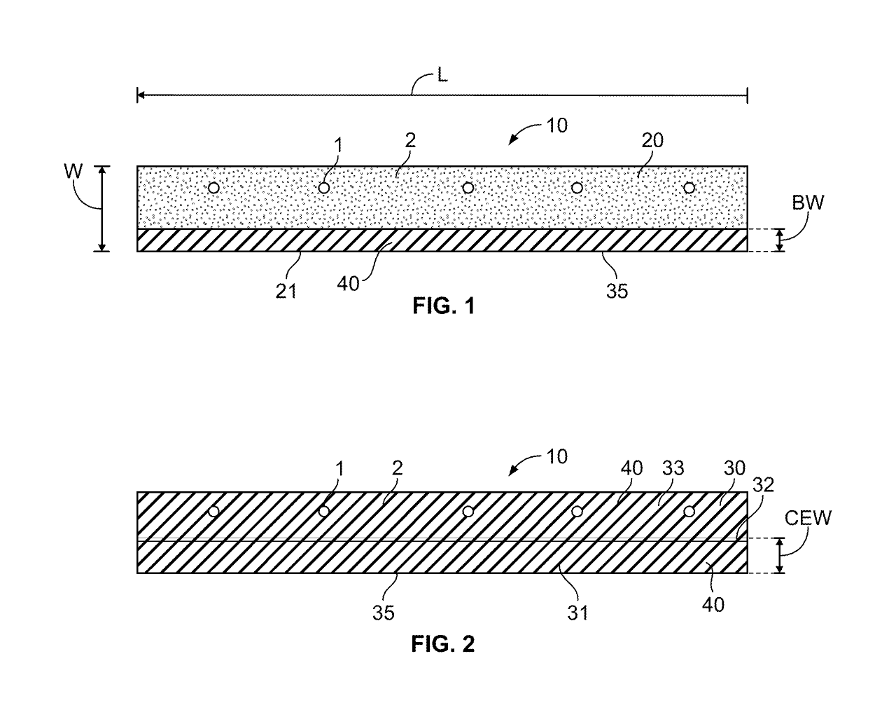

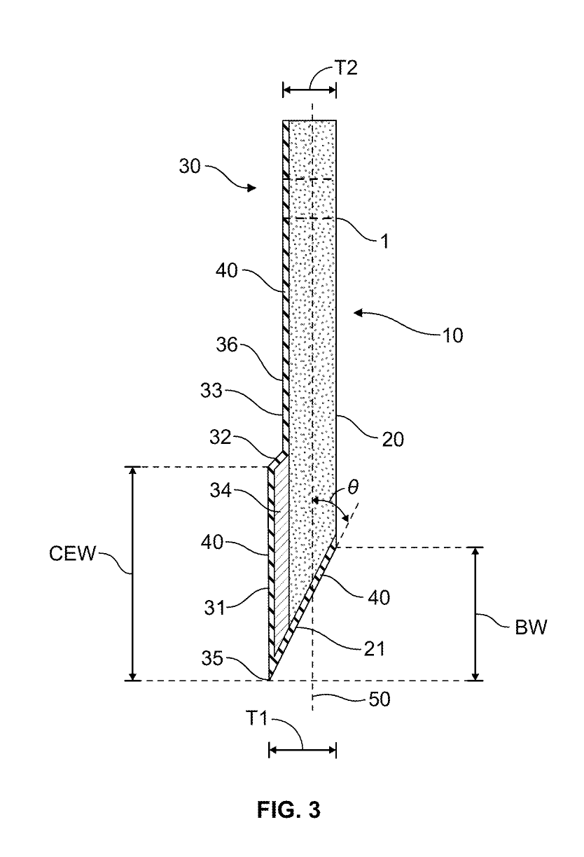

One possible configuration of the knife assembly of the present invention is shown in the accompanying figures. FIGS. 1 and 2 show respectively the back and front sides of one embodiment of the industrial knife 10 of my disclosure. The knife is preferably made from metal stock material having a width W, a length L and a thickness T1 (see FIG. 3). Preferably, length L is in the range from about 6 inches to about 165 inches and W is in the range from about 2 inches to about 24 inches. The knife is preferably is fabricated from carbon steel, D-2, high-speed steel, carbide inlaid material, ceramics and other similar hardened materials.

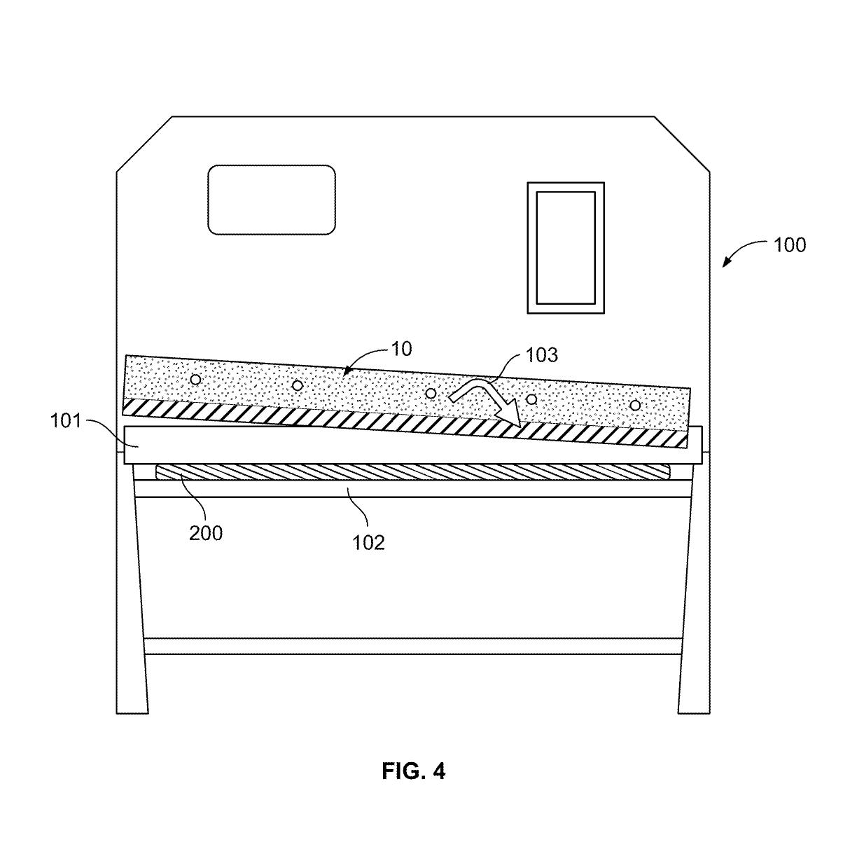

FIG. 1 shows a front beveled side 20 and FIG. 2 shows the back cutting side 30 of knife 10. Through holes 1 are located in the upper sections 2 of both sides. These through hole are configured to allow an attachment feature 3, such as a screw or bolt, to pass through the knife to allow the knife to be mounted on a cutting machine as illustrated in FIG. 4. Each side of knife 10 has a blade face on the lower portion of the knife shown as bottom blade faces 21 and 31. The bottom blade face 21 of front beveled side 20 has a beveled edge of width BW. This beveled edge is angled with respect to longitudinal axis 50. As best illustrated in FIG. 3, the angle θ of the beveled bottom blade face 21 is preferably less than 90 degrees as measured relative to a longitudinal axis 50 that is parallel to width W of knife 10. A preferred angle θ is in the range from about 10 degrees to about 40 degrees and most preferably from about 18 to about 30 degrees. The bottom blade faces 21 and 31 join together at the bottom of knife 10 terminating in a sharp cutting edge 35. The width BW of bottom blade face 21 can be in the range from about 0.5 inches to about 2 inches, most preferably 0.75 inches to 1.375 inches.

The lower blade face 31 of the back cutting side 30 has a cutting edge width of CEW and can taper inward relative to cutting edge 35 at a taper of from 0.003 to about 0.005 inches measure along the width of knife 10. The width CEW of the lower blade face 31 can be in the range from about 0.5 inches to about 2 inches, most preferably 0.75 inches to 1.375 inches. The transition between the lower blade face 31 and the upper portion 2 is indicated by transition 32, which is more clearly shown in the side view of FIG. 3. For this particular embodiment the transition is approximately a 45 degree transition, however, the transition angle may be more or less depending on the method used to create the recess 36. Preferably, CEW is greater than BW and L >H >CEW. In one preferred configuration of the knife 10 the lower blade face 31 of the back cutting side 30 and the collection surface 33 each have a different width measured along the longitudinal axis and where the width of collection surface is at least twice the width of the lower blade face of the back cutting side.

FIG. 3 presents a side view of knife 10 that shows a preferred lower blade face 31 comprising a hardened metal insert 34. This hardened metal can be selected from the group consisting of carbon steel, D-2, high speed steel, tungsten carbide, T1 (18% tungsten alloy), and ceramics. The insert 14 is preferably attached to a slot or pocket formed in the knife 10 and then held in place by known brazing techniques. The depth of the pocket or slot is deep enough to accept and hold an insert having a thickness of from about 2 to about 3 mm. The use of the hardened insert 34 on the back cutting side of knife 10 allows for easier sharpening of the beveled bottom blade face 21 on the front beveled side 20.

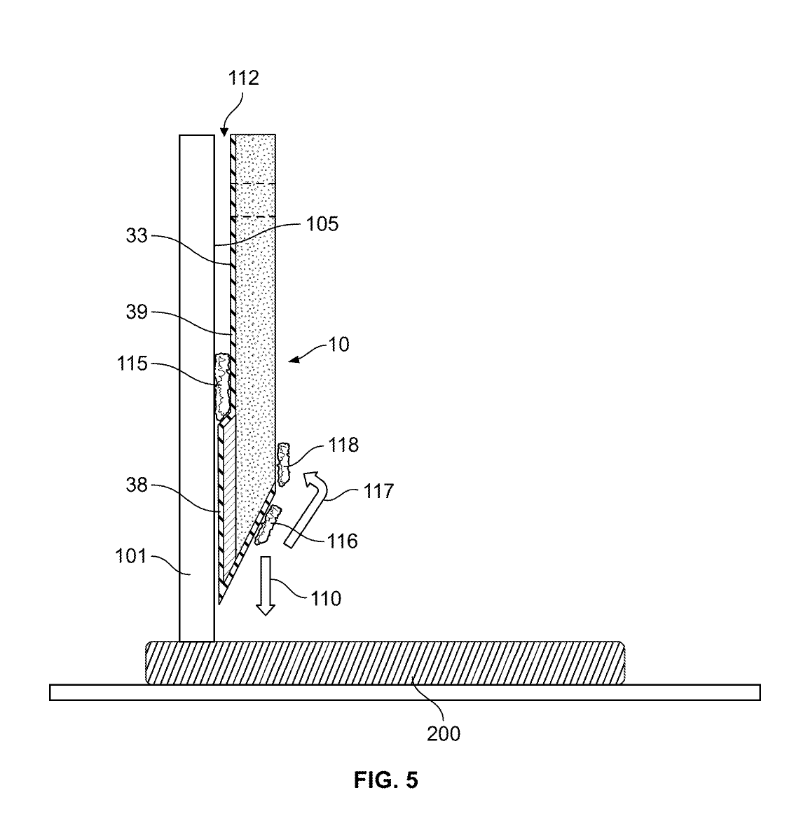

FIG. 3 also illustrates, in an exaggerated thickness, the location of low friction coatings 40. The same or different coatings can be applied to different areas of the knife provided these coatings each exhibit a low coefficient of friction. Preferred chemical compounds used to form the low friction coatings include fluoroplastic resins, preferably one or more selected from the group consisting of PTFE (polytetrafluoroethylene), FEP (fluorinated ethylene propylene copolymer), PFA (perfluoroalkoxy), ETFE (a copolymer of ethylene and tetrafluoroethylene), and dry lubricant coatings that are designed to provide lubrication under high-pressure/velocity (PV) conditions. Such dry lubricant coatings are solvent-based, one-coat systems that are usually cured between 500° F. and 700° F. Yet other low friction coating can be made using one or more of these fluoroplastic compounds that are mixed with other high-performance resins to improve toughness and abrasion resistance. Typically, to form the low friction coatings the fluoroplastic compounds must be applied to the knife and then baked or cured at high temperatures to adhere the low friction coating to the knife surfaces. Before adding the coating, the surface of the recess 36 is roughened, for example by grit or sand blasting, to allow for good adherence of the coating and to remove any oils or other substances that would interfere with the coating. A preferred thickness of the coating is from about 1 mil to about 2 mils, however, the maximum amount of applied coating is a function of the gap clearance between the installed knife and the clamp on the cutting machine (see FIG. 5). Too thick a coating can cause the knife to rub against the clamp during the cutting machine oeration.

The thickness of knife 10 can vary from width T1 to T2, where T2 <T1, as best shown in FIG. 3. This variable thickness is a function of the extent of the depth of the recess or cut-out section 36 on the back cutting side 30. Preferably, T1 is in the range from about 0.250 inches to about 1.0 inches and the difference between T1 and T2 is in the range of from about 0.010 inches to about 0.020 inches. In a preferred design the surface of the lower blade face 31 of the back cutting side 30 defines a plane that is above a plane defined by the collection surface 33, where the planes are not parallel to each other because of the slight tapering inward of the lower blade face. A preferred method of forming the recess is to use a grinding operation where the metal in the upper portion of the back cutting side 30 is ground down to the desired depth. Depending on depth needed, either grinding equipment or a milling machine could be used to form the recess 36. The type of operation used to create the recess will typically dictate the angle of transition 32. The width of the recess must be wide enough to efficiently collect the transferred adhesive. Preferably the recess will extend to the top of the knife as illustrated in FIG. 3.

Turning next to FIG. 4, there is generally shown a cutting machine 100, preferably a paper cutter, having knife 10 mounted thereon through fasteners 3. Movable clamp 101 is shown holding down a lift of media 200 supported by table 102 of the cutting machine 100 as knife 10 begins moving downward to make a cut. My industrial knife can be used in cutting machines that operate with only a single knife installed or can be used on multiple knife cutting machines, such as, a three-knife or five-knife book trimming machine. As mentioned, the knife 10 has a plurality of attachment through holes 1 that can be used with appropriate fasteners 3 to removably connect the knife 10 to cutting machine 100. These through holes may be round holes, slots, grooves, or other attachment means that are configured to align and cooperate with similar means or fasteners located on the cutting machine. Preferably, when attached to a cutting machine 100 the knife is operated in a reciprocal manner, as opposed to a rotary manner. In other words, the cutting machine causes the knife assembly to move in a radial “up and down” cutting motion from left to right (or from right to left), as opposed to a rotational direction like that of an electric table or radial arm saw blade. This cutting motion is generally shown by directional arrow 103.

Turning now to FIG. 5, which schematically represents a cross-sectional view of one embodiment of my industrial knife as it would be generally positioned in a cutting machine, there is clamp 101 to exert a clamping force in the direction 110 to hold media 200 in a fixed position as knife 10 is also moved downward left to right (or right to left) slicing motion at a prefixed angle. The positioning of knife 10 relative to clamp 101 is such that there is an abutment between the front side 105 of clamp 101 and the coated cutting surface 38 of the bottom blade face 31. A gap 112, shown exaggerated in FIG. 5, exists between the front side 105 of clamp 101 and the recess 36. Accumulated adhesive residue 115 is shown collecting on the collection surface 33. As the blade 38 makes repeated cuts during the up and down motion, the released adhesive from the media that sticks to the knife 10 and collects on the blade surface 38 will be pushed, scraped or otherwise forced off of blade surface 38 and moved into the recess 36 and deposited on collection surface 33 as adhesive residue 115. Likewise, any adhesive 116 that might stick to blade surface 28 on the front cutting side 20 of knife 10 will be pushed or otherwise transferred in the direction indicated by directional arrow 117 to the non-beveled front of knife 10 as illustrated by the collected adhesive residue 118. The movement or transfer of the adhesive residue from blade surfaces 38 and 28 is a direct result of the low friction coating 40. Because of the low friction coating any build-up of the adhesive on the collection surface can be easy wipe of from the coated surfaces using a rag and small amount of solvent without the need for dissembling the knife from the cutting machine. The clamp 101 and the knife 10 are perpendicular to the lift of media 200 during the cutting or trimming operation.

Exemplary embodiments of the present invention have been described. Those skilled in the art will understand, however, that changes and modifications may be made to these embodiments without departing from the true scope and spirit of the present invention, which is defined by the claims.

1. An industrial knife for use in a trimming or cutting machine comprising:
a metal stock material having a length L and a width W and having a front beveled side and a back cutting side,
wherein the front beveled side comprises,
a bottom blade face that is beveled to angle less than 90 degrees as measured relative to a longitudinal axis parallel to width W; and
a low friction coating present on an outer surface of the bottom blade face;
wherein the back cutting side comprises,
a lower blade face and an upper end portion, where the upper end portion is recessed from the lower blade face to define a collection surface; and
a low friction coating present on an outer surface of the lower blade face and on the collection surface.

2. The knife of claim 1 further characterized in that L is greater than W.

3. The knife of claim 1 further characterized in that the bottom blade face of the front beveled side has a width that is smaller than the lower blade face of the back cutting side.

4. The knife assembly of claim 1 further comprises an upper end portion having a plurality of attachment features for removably connecting the assembly to a cutting machine.

5. The knife of claim 4 further characterized in that the attachment features are configured as through holes for inserting fasteners.

6. The knife of claim 1 further characterized in that the lower blade portion of the back cutting side comprises a hardened metal selected from the group consisting of carbon steel, D-2, high speed steel, tungsten carbide, T1, and ceramics.

7. The knife of claim 1 further characterized in that the bottom blade face of the front beveled side is beveled to angle between about 18 to about 30 degrees.

8. The knife of claim 1 further characterized in that the low friction coating on the front beveled side and the back cutting side comprises polytetrafluoroethylene.

9. The knife of claim 1 further characterized in that the lower blade face of the back cutting side transitions into the upper end portion at an angle of about 45 degrees.

10. The knife of claim 1 further characterized in that lower blade face of the back cutting side and the collection surface each have a different width measured along the longitudinal axis and where the width of the collection surface is at least twice the width of the lower blade face of the back cutting side.

11. The knife of claim 1 where the surface of the lower blade face of the back cutting side defines a plane that is at least about 0.010 to about 0.020 inches above a plane defined by the collection surface, where both planes are not parallel to each other.

12. A method of retrofitting an industrial paper knife to reduce adhesive build-up during use comprising,
a) providing a paper knife comprising,
a metal stock material having a length L and a width W and having a front beveled side and a back cutting side, where the front beveled side comprises a bottom blade face that is beveled to angle less than 90 degrees as measured relative to a longitudinal axis parallel to width W, where the back cutting side comprises a lower blade face and an upper end portion;
b) removing a section of the upper end portion of the back cutting side to form a collection surface;
c) applying a low friction coating on an outer surface of the bottom blade face of the front beveled side; and
d) applying a low friction coating on an outer surface of the lower blade face and on the collection surface.
